(19) United States
(12) Patent Application Publication
(10) Pub. No.: US 2024/0063752 A1
(43) Pub. Date: Feb. 22, 2024

(54) MODULAR STRUCTURE PHOTOVOLTAIC DEVICE

(71) Applicant: LEVANTE S.R.L., Milano (IT)

(72) Inventor: Myklebust KIM JOAR, Milano (IT)

(21) Appl. No.: 18/259,271

(22) PCT Filed: Dec. 23, 2021
(86) PCT No.: PCT/IB2021/062265

§ 371 Date: Jun. 25, 2023

(30) Foreign Application Priority Data
Dec. 30, 2020 (IT) 202020000007181

(51) Int. Cl. H02S 30/20; H02S 40/36

(52) U.S. Cl. CPC H02S 30/20; H02S 40/36

(57) ABSTRACT

A photovoltaic device (D) comprises by at least two modules (M) connected to each other, each module (M) is being formed by a relative flat panel (P), on whose front surface (Ps) a plurality of photovoltaic cells (CF) are mounted and arranged; the modules (M) can be folded over each other between in a closed position of minimum encumbrance of the device (D) and an open operative position of maximum encumbrance of the device (D) for an effective capture of solar radiation.

This model relates to a photovoltaic device with a modular structure.

In particular, the model in question is advantageously used for the conversion of solar radiation into available energy, for example for the production of available electricity and for use in the civil and/or industrial field, to which the following description will explicitly refer without losing its generality. The purpose of the present model is that of realizing a photovoltaic device with a modular and foldable structure. When folded it has a smaller footprint and can therefore be easily and quickly transported and installed on site with simplified operations.

Another object of the present model is to provide a photovoltaic device with a compact modular structure that will be capable of being advantageously used in various places, different from traditional placements such as rooftops of buildings.

A further object of the present model is to provide a photovoltaic device with a modular structure which is easy and quick to maintain.

The structural and functional characteristics of the model in question and its advantages with respect to the known technique will be even more clear and evident from the claims below. In particular from an examination of the following description, that refers to the attached drawings, which show the schematics of a preferred but not limiting configuration of the photovoltaic device with a modular structure in question, in which:

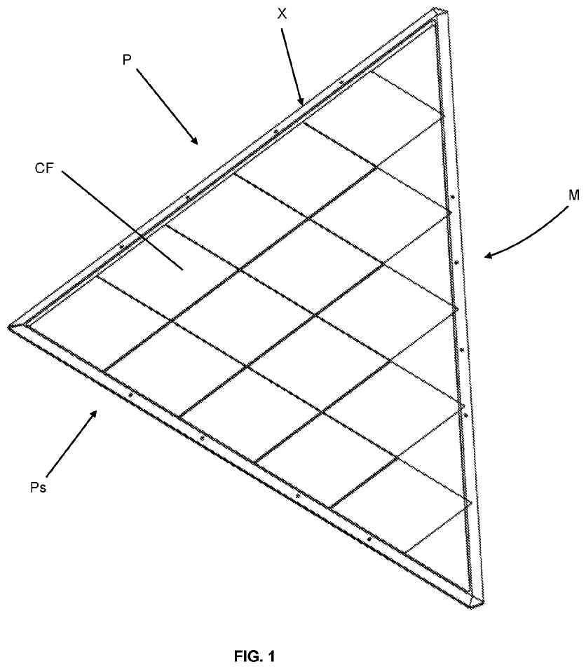

FIG. 1 is a plan view on an enlarged scale of a modular component of the photovoltaic device object of the present utility model;

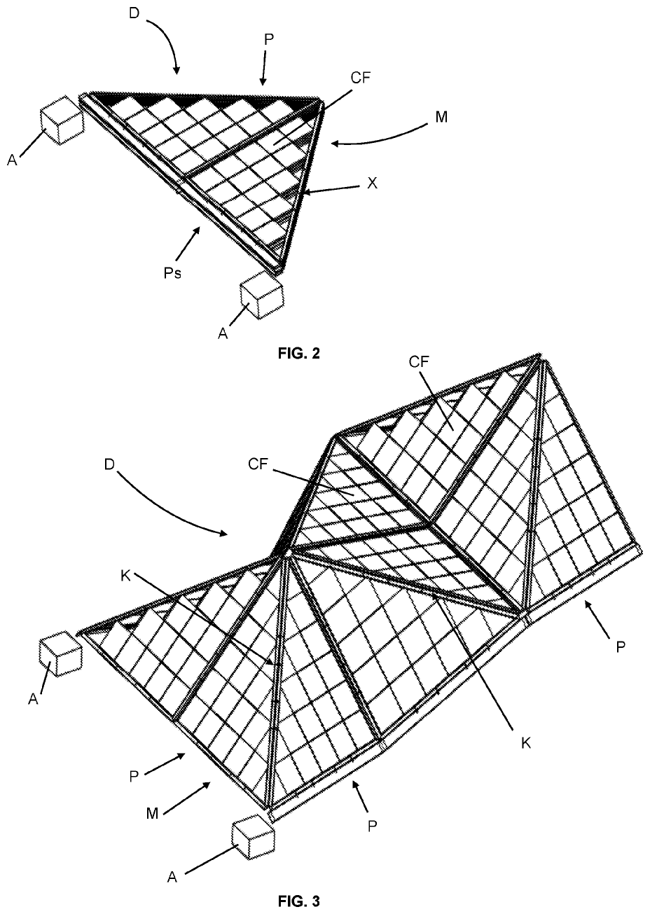

FIG. 2 is a plan view of the modular photovoltaic device in question, shown in its own minimum closed and transportable position;

FIG. 3 is a perspective view of the photovoltaic device of FIG. 2, shown in its own intermediate position with a certain opening configuration;

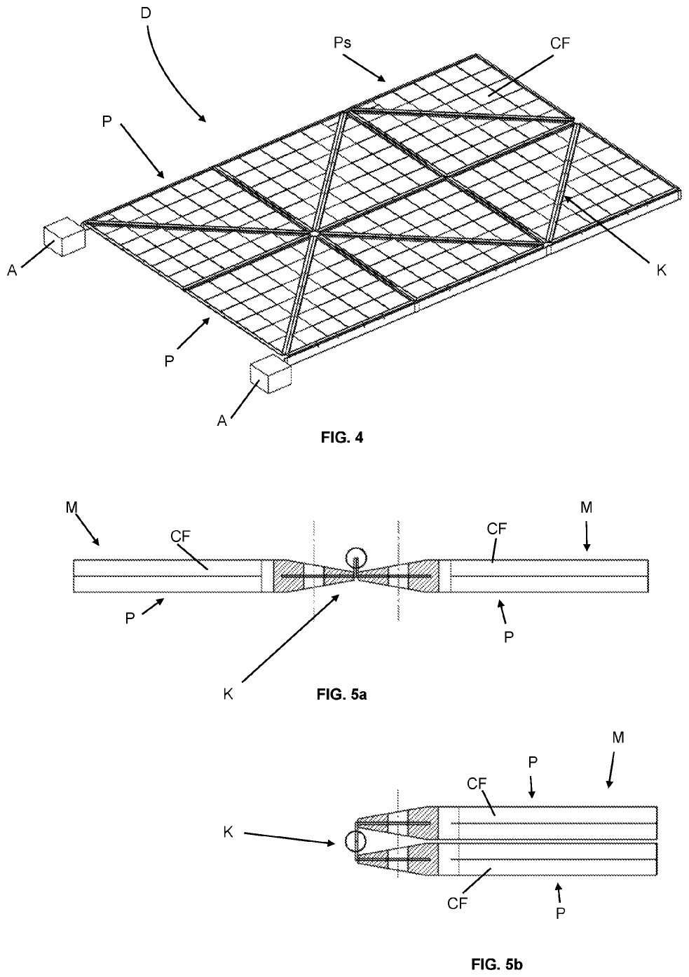

FIG. 4 is a front perspective view of the photovoltaic device of FIGS. 2 and 3, shown in its open and operating position; and

FIGS. 5a and 5b show, on an enlarged scale and partially in section, with some construction details of the photovoltaic device in question, respectively in the position of FIG. 4 and FIG. 2. With reference to the attached Figures, D is globally and schematically indicating a photovoltaic device with a modular structure for capturing solar energy and its subsequent conversion into electricity that can be used in numerous fields and sectors.

According to what is better illustrated in FIG. 4 and also in FIGS. 1 and 2, the device D comprises a plurality of modules M. Each module M being defined by a flat panel P, preferably but not limitedly with a isosceles right triangle extension shape, on which the front surface Ps a plurality of rectangular photovoltaic CF cells are mounted and arranged, suitable for capturing solar radiation in correspondence with an operating configuration, in particular completely flat and open (FIG. 4).

According to an alternative version not shown, the flat P panel has a different shape extension, for example square, rectangular or other similar geometric configuration.

Preferably but not limitedly, the CF cells which are centrally located on the aforementioned panel P can be bi-facial.

Each triangular P panel is provided with a perimeter frame X made of recycled material, or a composite material or equivalent, or, again, alternative materials like metal, polymeric and ceramic. In each module M, the surface Ps of the panel P is also preferably covered with a transparent polymeric protective film (or glass or similar) suitable for protecting the photovoltaic CF cells arranged on the panel P itself.

According to what is illustrated in FIGS. 5a and 5b, on the frame X of each panel P there are mounted means of interconnection K between the various modules M. This allows the modules M of the device D to be able to be folded back one on top of the other to form a closed configuration of minimum bulk and easy transport, illustrated and well schematized in FIG. 2.

Preferably, but not limitedly, the aforementioned means of interconnection K comprise hinges, with single or multiple rotation axes or fulcrums, or snap-fit means or similar, preferably also provided with electrical connection elements.

From the aforementioned closed configuration, the various modules M that can be folded over each other are progressively brought, automatically by the means of actuator A of a known type, which are an integral part of the device D, or alternatively manually, up to the aforementioned open operating position of FIG. 4 and vice versa, passing through an intermediate configuration illustrated in FIG. 3, forming an origami arrangement or equivalent arrangement.

Advantageously, this origami arrangement can also be adapted to the space in which the device D is arranged, mounted and used, or to allow an arrangement directed in an optimal and effective way towards solar radiation during the earth's rotation of the day.

Finally, it should be noted that the device D described above can also provide, directly integrated on the device D itself, some means for regulating the electric voltage.

1. Photovoltaic device (D) comprising at least two modules (M) connected to each other, each module (M) being formed by a relative panel (P) with flat extension, on the front surface (Ps) of which a plurality of photovoltaic cells (CF) are mounted and arranged; said modules (M) being pivoted to each other and foldable on each other between a closed position of minimum encumbrance of said device (D) and an open operative position of maximum encumbrance of said device (D) for the effective capture of solar radiation.

2. Device according to claim 1, wherein said panel (P) has an isosceles triangular extension at right angles.

3. Device according to claim 1, wherein said photovoltaic cells (CF) are monofacial.

4. Device according to claim 1, wherein said surface (Ps) of said panel (P) is covered with a transparent protective film.

5. Device according to claim 1, wherein the photovoltaic cells (CF) are bi-facial.

6. Device according to claim 1, wherein said triangular panel (P) is provided with a perimeter frame (X).

7. Device according to claim 6, wherein said perimeter frame (X) is made of recycled material, composite material or equivalent, or alternative materials such as metal, polymeric, ceramic.

8. Device according to claim 1, wherein said modules (M) are connected to each other by means (K) of interconnection of the hinge type.

9. Device according to claim 8, wherein said hinge means have several rotation axes.

10. Device according to claim 8, wherein said interconnection means (K) also comprise electrical connection elements.

11. Device according to claim 1, wherein said closed and open positions are arranged between an intermediate configuration forming an origami arrangement.
